(19) United States
(12) Patent Application Publication
(10) Pub. No.: US 2025/0138378 A1
(43) Pub. Date: May 1, 2025

(54) COLOR ELECTROPHORETIC DISPLAY AND DISPLAY METHOD OF THE SAME

(71) Applicant: TPK Touch Solutions (Xiamen) Inc., Xiamen (CN)

(72) Inventors: Feng-Cheng HSU, Taipei City (TW); Chien-Lin CHENG, Taipei City (TW); Chien-Min LAI, Taipei City (TW); An-Lun HAN, Taipei City (TW)

(21) Appl. No.: 18/806,783

(22) Filed: Aug. 16, 2024

(30) Foreign Application Priority Data
Nov. 1, 2023 (CN) 202311441227.5

(51) Int. Cl. G02F 1/153; G02F 1/163; G06F 3/0354

(52) U.S. Cl. CPC G02F 1/1533; G02F 1/163; G06F 3/03545

(57) ABSTRACT

A color electrophoretic display and a display method thereof are provided. The color electrophoretic display comprises an achromatic color particle and a plurality of chromatic color particles. The display method of the color electrophoretic display comprises turning on a stylus mode, providing an assigned stylus color, sensing a movement of the stylus to output a black trace, and transferring the black trace into a color trace of the assigned stylus color when the stylus movement stops. The black trace is shown when the achromatic color particle and the chromatic color particles move toward a top electrode, and a refresh time of the color of the black trace is smaller than 50 ms. The color of the assigned stylus color and the color of the black trace have brightness difference and at least one of the hue differences and the saturation differences.

### CROSS-REFERENCE TO RELATED APPLICATION

The instant application claims priority to China Patent Application 202311441227.5, filed on Nov. 1, 2023, which is incorporated herein by reference.

### FIELD OF DISCLOSURE

The present disclosure relates to a color electrophoretic display and a display method of the same.

### BACKGROUND OF THE DISCLOSURE

An electrophoretic display performs color-changing display by modifying the position of a charged colored particle with respect to a viewing surface, commonly known as “E-paper”. Electrophoretic displays have been widely used in E-readers or advertising boards.

Recently, color electrophoretic displays are available commercially. Applications of electrophoretic displays have expanded to include functions of E-note for writing notes in multi-colors. However, color electrophoretic displays must precisely control the position of each type of color particles. When the electrophoretic medium comprises multiple types of particles, the time necessary for adjusting the position of the particle is longer than that of an achromatic color display. Color electrophoretic displays contain many and complex types of particles therewithin (in comparison to those of achromatic color displays). Hence, the impact factors on the movements of the particles are even more complicated, including the time for switching the electric field, the force of attraction among particles, the mutual attraction/repulsion between particles during a movement, the collision between particles along the moving path, etc. As a result, the time for color switching of a color electrophoretic display is comparatively longer due to the aforementioned impact factors. For instance, a refresh time of changing colors may be nearly 500 ms. In other words, color electrophoretic displays need at least 500 ms to refresh and display the next frame of images having different colors. As a result, the refresh rate of showing writing of a user on color electrophoretic displays is low, which is known as “delay writing” and leads to unsatisfied customer experience.

A patent in Taiwan ROC, TWI400674B, for instance, uses a prediction method for predetermining possible line drawings in advance, in order to reduce the response latency of the pen/stylus/finger writing on electrophoretic displays. Nevertheless, the prediction method for predetermining possible line drawings must correct the error of prediction timely. For a multi-color system with various color particles, it is not simple to move particles around. When an error of prediction of line drawings needs to be corrected, it takes additional time to move and re-arrange particles again. Therefore, the method disclosed in Patent TWI400674B is not suitably applicable to electrophoretic display systems with multiple color particles.

In view of aforementioned problems of the prior art, how to provide a color electrophoretic display free from the issue of response latency that may lead to unsatisfied customer experience, is one of the goals for the industry to achieve.

### SUMMARY

The technology aspect of the present disclosure is a display method of color electrophoretic displays, in which the color electrophoretic display comprises an achromatic color particle and a plurality of chromatic color particles.

In one embodiment, the display method of the color electrophoretic display comprises: turning on a stylus mode, providing an assigned stylus color, sensing a movement of the stylus to output a black trace, and transferring the black trace into a color trace of the specified stylus color when the movement of the stylus stops. A color of the black trace is shown when the achromatic color particle and the chromatic color particles move toward a top electrode, and a refresh time of the color of the black trace is smaller than 50 ms. A color of the assigned stylus color and the color of the black trace have a brightness difference and at least one of a hue difference or a saturation difference.

In one embodiment, the color of the black trace has a shortest refresh time among colors of the color electrophoretic display.

In one embodiment, a refresh time of the assigned stylus color is 5-10 times that of the color of the black trace.

In one embodiment, the achromatic color particle is a white particle, and the chromatic color particles are cyan particles, yellow particles, and magenta particles.

In one embodiment, a distance between the black trace and the stylus tip is smaller than 3 mm.

In one embodiment, the display method of the color electrophoretic displays further comprises: determining whether a color difference between the assigned stylus color and the color of the black trace is larger than 13. When the color difference is larger than 13, the system will re-select a color family, having a color difference less than 13, and assign a color having a shortest refresh time from the aforementioned color family to the stylus color. The trace is then displayed in this assigned stylus color.

In one embodiment, the display method of the color electrophoretic displays further comprises: sensing a pressure of the stylus pressing against the color electrophoretic display screen to determine that the stylus touches the color electrophoretic display screen and begins to draw based on the pressure increasing.

In one embodiment, the display method of the color electrophoretic displays further comprises: sensing a pressure of the stylus pressing against the color electrophoretic display screen to determine that the stylus moves away from the color electrophoretic display screen and stops drawing based on the pressure decreasing.

In one embodiment, the step of providing an assigned stylus color is prior to or after the step of sensing the contact of the stylus.

Another technology aspect of the present disclosure is a color electrophoretic display. The color electrophoretic display comprises an achromatic color particle and a plurality of chromatic color particles. A color trace, formed by the movement of the stylus, is shown when the achromatic color particle and the chromatic color particles move toward a top electrode. A distance between an endpoint of the color trace and a tip of the stylus is smaller than 3 mm, and the color electrophoretic display does not comprise color filters.

In one embodiment, the color trace is presented in an assigned color which is changed from a color having a highest refresh rate. The display comprises particles which only have white particles, cyan particles, yellow particles, and magenta particles. The assigned color or the first color is presented by moving three kinds or two kinds of the particles to the top electrode, or the assigned color is presented by moving only one kind of cyan particles, yellow particles, and magenta particles to the top electrode. The color trace is presented in an assigned color which is changed from a black color which is presented by moving four kinds of the particles to the top electrode. The black color is presented in a time period less than 50 ms. The color trace is presented in an assigned color, which has a refresh time higher than a visual recognizing time, and the assigned color is changed from a black color, which has a refresh time higher than the visual recognizing time.

In the aforementioned embodiment, the display method of the color electrophoretic displays is to display the black trace first as users will not sense the delay of the trace. After the trace is displayed, the color rendering step proceeds. Under the condition that the black trace has been displayed, a delay in color rendering will not be noticeable. The process helps to enhance the positive impact on customer experience. Therefore, the display method of the color electrophoretic displays of the present disclosure improves the delay in displaying traces and, at the same time, provides effects of color traces.

### BRIEF DESCRIPTION OF THE DRAWINGS

FIG. 1 is a schematic sectional view of the color electrophoretic display based on one embodiment of the present disclosure.

FIG. 2 is a schematic sectional view of the color electrophoretic display based on one embodiment of the present disclosure.

FIGS. 3A-3D are schematic diagrams illustrating positions of different particles in the color electrophoretic display while displaying different colors based on one embodiment of the present disclosure.

FIG. 4 is a display method of the color electrophoretic display based on one embodiment of the present disclosure.

FIG. 5 is a schematic diagram of a middle step of the display method described in FIG. 4.

FIG. 6 is a schematic diagram of a middle step of the display method described in FIG. 4.

### DETAILED DESCRIPTION

A plurality of embodiments of the present disclosure will be disclosed below with reference to drawings. For purpose of clear illustration, many details in practice will be provided together with the following descriptions. However, these detailed descriptions in practice are for illustration only and should not be interpreted to limit the scope, applicability, or configuration of the present disclosure in any way. That is, in some embodiments of the present disclosure, these details in practice are not required. Furthermore, for purpose of simplifying drawings, some structures and components of the prior art shown in the drawings will be illustrated schematically. For better illustration, the thickness of layers and areas in the diagrams may be overstated, and identical component symbols in the diagrams represent identical components.

The term “bistable” and similar terms used in this specification refer to an optical phenomenon of a display device achieving at least two different display states, such as the first display state and the second display state, at the same input, switching between the first display state and the second display state upon receiving the input, and remaining stable in the first display state and the second display state. In addition, some display devices can remain stable in the intermediate state of the aforementioned first display state and second display state, and are called “multi-stable” display devices. For convenience of communication, “bistable” display devices also refer to “multi-stable” display devices in the present disclosure.

Some embodiments of the present disclosure relate to electro-optic displays, especially bistable electro-optic displays. For example, electrophoretic displays use a type of display technology based on reflection of ambient light by particles, in which one kind or multiple kinds of colored (black, white, or color)/charged particles in a fluid (hereinafter called the “electrophoretic medium”) and move around within the fluid driven by the electric fields or/and magnetic fields to change the appearance (display screen/frame) of the display devices. The color electrophoretic displays in some embodiments of the present disclosure use materials (such as colored/charged particles) that can produce the first display state and the second display state. By applying electric fields or/and magnetic fields to the aforementioned material, the appearance of the material switches from the first display state to the second display state, in which the first display state and the second display state have at least one of the optical property differences (such as hue, brightness, and saturation).

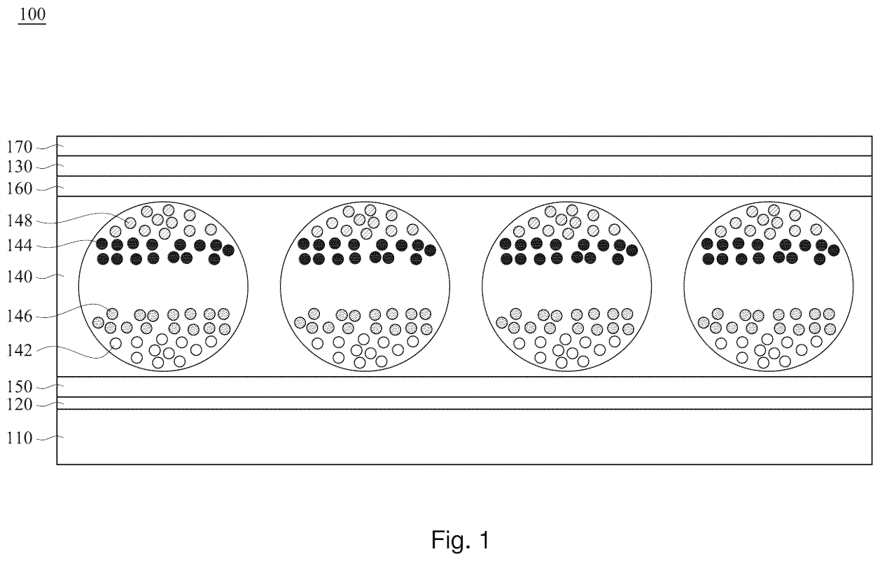

FIG. 1 is a schematic sectional view of the color electrophoretic display 100 based on one embodiment of the present disclosure. The color electrophoretic display 100 comprises a substrate 110, bottom electrodes 120, top electrodes 130, and an electrophoretic medium 140. The thin film transistor (TFT) disposed on the substrate 110 constitutes an active pixel matrix. The bottom electrodes 120 in an array setting are pixel electrodes, and intersections of the pixel electrodes correspond with pixels displayed in the color electrophoretic display 100 to constitute an image display in an array configuration. The bottom electrodes 120 and the electrophoretic medium 140 have an adhesive layer 150 therebetween, the top electrodes 130 and the electrophoretic medium 140 have an adhesive layer 160 therebetween, and a protective layer 170 is disposed on the top electrodes 130 to protect the top electrodes 130.

The bottom electrodes 120 and the top electrodes 130 can be transparent conductors, for example, indium tin oxide (ITO) or indium zinc oxide (IZO) that is deposited on the transparent substrate or polyethylene terephthalate (PET) or polyimide (PI) that is fabricated as electrodes through the patterning step. The bottom electrodes 120 and the top electrodes 130 can be made of flexible conductive materials, for example, metal nanowire (silver nanowire), conductive polymers, or polymers with conductive additives.

The electrophoretic medium 140 of the color electrophoretic display 100 in some embodiments of the present disclosure comprises four different types of particles, in which each type of particles has, but is not limited to, different diameter, color, charge (positive charge, negative charge, or quantity of charge), and/or electron mobility. In this embodiment, for example, the electrophoretic medium is composed of white particles 142, cyan particles 144, yellow particles 146, and magenta particles 148, in which the white particles 142 are achromatic color particles and reflective particles. The cyan particles 144, yellow particles 146, and magenta particles 148 are chromatic color particles and are also the subtractive particles. The electrophoretic medium 140 is provided in a micro capsule or a micro cup and fabricated on the substrate 110 through methods such as coating, laminating, or spraying. In this embodiment, the color electrophoretic display 100 can have many millions of different colors using the aforementioned ink system of 4 different particles. In addition, every pixel in the color electrophoretic display 100 can display the full gamut of colors.

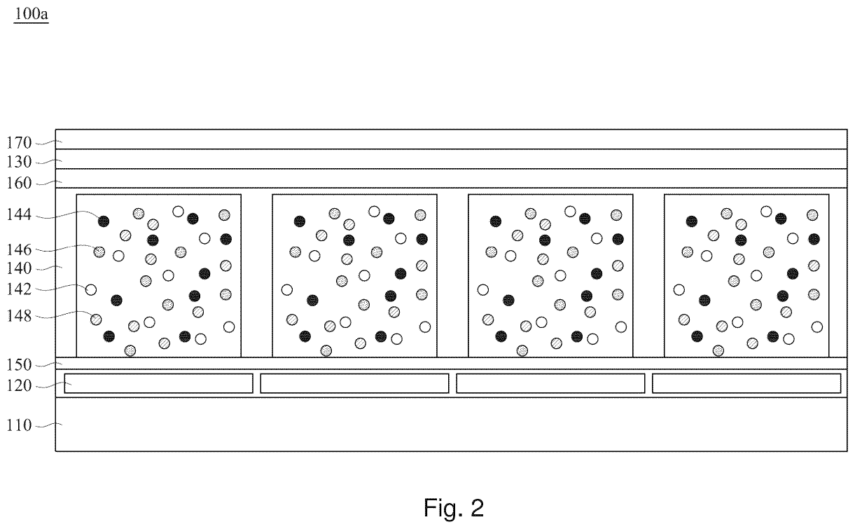

FIG. 2 is a schematic sectional view of the color electrophoretic display 100a based on one embodiment of the present disclosure. The electrophoretic medium 140 is distributed in micro units or cavities in which the cavities are separated by the medium or polymers. The bottom electrodes 120 are corresponding to micro units in partitioned regions in order to drive particles in each micro unit separately. The color electrophoretic displays 100, 100a disclosed in the present disclosure are not limited to the aforementioned forms. The present disclosure can further relate to, for instance, electrophoretic displays with the electrophoretic medium 140 having a composite of achromatic color particles and chromatic color particles. For example, electrophoretic displays with the electrophoretic medium 140 can have black particles, red particles, green particles, and blue particle. Alternatively, electrophoretic displays with the electrophoretic medium 140 can have black particles, red particles, yellow particles, and blue particles. Alternatively, electrophoretic displays with the electrophoretic medium 140 can have black particles, white particles, red particles, and yellow particles.

In the aspects of displaying colors, the term “achromatic” refers to black, white, and other gray colors, whereas switching the color from white to black only involves the change of brightness (to be quantified by lightness), without changes to hue (to be quantified by wavelength) and saturation (to be quantified by chroma). Taking CIELAB as an example for explanation, L * indicates lightness. L *=0 represents solid black color with a reflectance or a transmittance of 0%, L *=50 represents neutral gray, and L *=100 represents white color with a reflectance and clarity of 100%. The monochrome electrophoretic displays in the embodiment of the present disclosure refer to those only having achromatic color particles, namely the electrophoretic displays with white particles or black particles, in which switching the color of the display screen from white to black only involves the change of brightness (Δ L *) without changes to the hue and saturation. More specifically, the driving method of an electrophoretic display with only black particles and white particles is much simpler by separately driving the black particles and white particles, which have opposite electric charges respectively, toward the top viewing surface through the voltages of two different polarities (having a positive charge or a negative charge). During the moving process of black and white particles, the gray color will naturally appear. For example, in a picture presented with black color on an originally white background, while switching colors to be shown (switching black color to white color), the black particles move from the electrodes on the display surface (i.e., top electrodes 130) toward the electrodes on the driving surface (i.e., bottom electrodes 120), whereas the white particles move in the opposite direction. When two types of particles move around and are mixed in the electrophoretic medium 140, the gray color will naturally appear. In summary, in a system having two color particles of black and white, the appearance of gray color in the display is a natural phenomenon that is not created by specific computations or processes in the display system.

With respect to the “achromatic” white or black particles, the term “chromatic particles” in the present disclosure refers to particles with colors. For example, chromatic color particles that generate colors by reflecting light, in which the color variations caused by these chromatic color particles are not limited to brightness difference, but including hue difference, brightness difference, and saturation difference. Taking CIELAB as an example for explanation, in addition to L *, a * and b* may be different, resulting in color difference (i.e., Δ E available, namely the color difference). For instance, when a red color represented by a single magenta particle changes to the color of a mix of yellow and cyan particles, the changes in hue, brightness, and saturation in the color domain may occur. To achieve the aforementioned changes in hue, brightness, and saturation, complicated driving methods are used for controlling multiple types of chromatic color particles on the movement and mixture processes, in order to ensure the chromatic color particles set at the required locations to present the correct colors/images/patterns. In other words, the color electrophoretic display 100a of the present disclosure, in processing the coordination of electrophoretic particles or color control, is much complex than those of achromatic color electrophoretic displays.

For electrophoretic displays having multiple types of color particles, the particle driving methods thereof can be complicated. When a color electrophoretic display comprises four different types of color particles, the color electrophoretic display can create several thousand colored displays by accurately controlling relevant positions of each individual particle with respect to other particles. Among all, one driving method is to generate square wave pulses by the driving circuit disposed on the substrate 110 in multiple sets of different voltages that induce different particles to set up in different arranged manners, so as to ultimately produce the necessary colors on the viewing surface. However, when a color electrophoretic display has both multiple types of achromatic color particles and chromatic color particles, if a display screen is to show only black or white images, the response time is not faster than that of a pure achromatic color electrophoretic display. One objective of the present disclosure is to resolve and improve the delay of displaying images of the color electrophoretic display 100a. In particular, one objective is to provide a user-friendly display mode while drawing/writing on the color electrophoretic display 100a, so as to improve the experience of the user with respect to the response latency of pen writing.

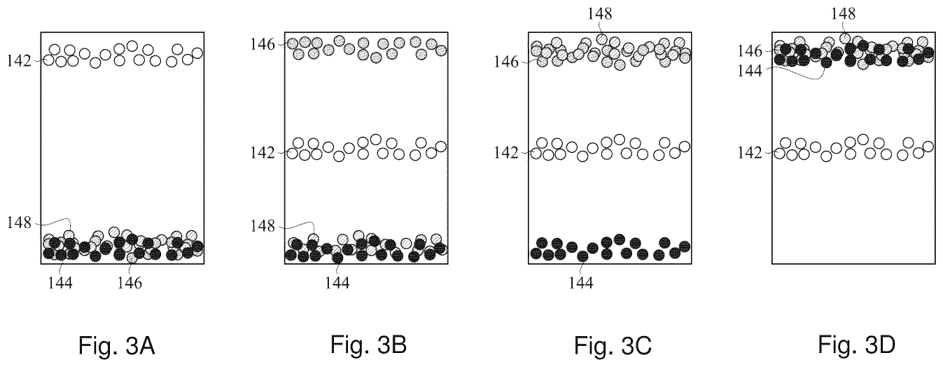

FIGS. 3A to 3D are schematic diagrams illustrating the positions of different particles in the color electrophoretic display while displaying different colors based on one embodiment of the present disclosure. The top edge is a viewing surface where the incident light occurs. Taking the electrophoretic medium 140 of the color electrophoretic display 100a illustrated in FIG. 2 as an example, in FIG. 3A, the white particles 142 reflect light, and the cyan particles 144, yellow particles 146, and magenta particles 148 are controlled by the electric fields and located below the white particles 142. Therefore, the white particles 142 can reflect incident light from the light source (for example, light from the surrounding areas, or a front light module of the color electrophoretic display 100a), causing white color to be displayed on the viewing surface (positioned above the top electrodes 130 illustrated in the figures of the present disclosure). In other words, the single color displayed (white color) indicates that the electric field between the bottom electrodes 120 and the top electrodes 130 have a driving effect to an extreme state and attract (or move) the white particles 142 close to the top electrodes 130, while other particles are away from (or not close to) the top electrodes 130. Thus, a single color is displayed. In FIG. 3B, the yellow particles 146 are located above the white particles 142, and the incident light penetrates the yellow particles 146 and is reflected by the white particles 142, causing the display screen to show yellow color. In the same token, the color electrophoretic display can also display cyan, magenta, red (shown in FIG. 3C), and blue colors. In FIG. 3D, there are three different color particles located above the white particles 142, and the screen display shows black color. In the embodiment, black color is a mix result of four different colors, namely white particles 142, cyan particles 144, yellow particles 146, and magenta particles 148. Therefore, a driving method allowing for an extreme state can be used. For example, by giving a maximum difference in voltage, the aforementioned particles driven by the high voltage difference will move toward the top electrodes 130 at the fastest speed to undergo color mixing. Due to the moving directions of these four different colors being practically the same, the aforementioned moving resistance can be minimized and the response time/refresh time to display the black color is reduced to the shortest time, for instance, smaller than 50 ms. In other words, the black color is the color having the fastest refresh rate in the display system of the present disclosure.

In another embodiment, the color electrophoretic display comprises particles of achromatic black particles as well as chromatic red particles, blue particles, and green particles. Black particles can absorb light. When the red particles, blue particles, and green particles are located below the black particles, the viewing surface appears to be black. When the red particles are located above the black particles, the viewing surface appears to be red. In the same token, when the blue particles are located above the black particles, the viewing surface appears to be blue. When the green particles are located above the black particles, the viewing surface appears to be green. When two different chromatic color particles are located above the black particles, the viewing surface can display mix colors of purple, orange, or yellow. When three different chromatic color particles are located above the black particles, the viewing surface displays white color.

Colors illustrated in FIGS. 3A to 3D can be achieved through several different methods. For example, one method drives charged particles to move within specific electric fields based on the differences in electrophoretic mobility. During the particle moving process, the electric field is adjusted to change in accordance to the change of particle distributions. Therefore, the necessary particles are located at the required locations close to the viewing surface to display the target colors through a plurality of stages of electric field adjustment.

In another embodiment, the strength of clustering between particles is adjusted through the surface processing on particles. One such method to achieve the aforementioned effect is to form polymers of different thickness on the particle surfaces. For example, in the embodiment, the white particles 142 have a negative charge, the cyan particles 144 have a positive charge, the yellow particles 146 have a negative charge, and the magenta particles 148 have a positive charge. In another embodiment, when different particles have different electric charges, the applied voltage should be adjusted in correspondence with the square wave pulses. The white particles 142 and the cyan particles 144 have a much thicker shell. Under such a condition, the force between the yellow particles 146 and the magenta particles 148 is the strongest, and hence a higher electric field is required to separate these particles. The force between the white particles 142 and the cyan particles 144 is the second strongest, and hence a higher electric field is required to separate these particles. The force between the white particles 142 and the cyan particles 144 is the second strongest, which is similar to that between the cyan particles 144 and yellow particles 146. The force between the white particles 142 and the cyan particles 144 is larger than that between the particles with the same electric charge. Based on the aforementioned features, when different levels of electric fields are applied, specific particles will gather together and move slowly. The specific charged particles move to the designated positions.

In one embodiment illustrated in the aforementioned FIGS. 3A to 3D, the color driving process can be achieved by five different voltages, comprising 2 sets of positive voltage, a zero voltage, and two sets of negative voltage. For example, the voltages can be 30 volts, 20 volts, 0 volt, −20 volts, and −30 volts. However, the present disclosure is not limited thereto. In other embodiments, more sets of positive voltage and negative voltage generate the necessary square wave pulses to achieve the effect of driving particles.

When white color is displayed, oscillating square waves ranging from 0 volt to −20 volts are applied, causing the white particles 142 to move toward the positions close to the viewing surface. When black color is displayed, oscillating square waves ranging from 0 volt to +20 volts are applied, causing three chromatic color particles to move above the white particles 142 in the positions close to the viewing surface. When chromatic colors are displayed, square waves oscillate between different voltage values, for example, from +30 volts to −20 volts, or from −30 volts to +20 volts. Furthermore, the duration and frequency of these different voltage values are adjusted according to what color to be displayed.

From the perspective of market trends, color electrophoretic displays are the direction of product development. However, as described above, color electrophoretic displays have abundant particles internally (in comparison with those in achromatic color electrophoretic displays), and the impact factors of particle movements are complicated (for example, switching electric fields, attractive force between particles, resistance from obstacles during particle movement) resulting in longer time for switching color in the color electrophoretic displays and delays of displaying the screen image. In addition, the integration of display devices and handwriting inputs (or other kinds of inputs) is a function demanded by users. Therefore, using the pen/hand/stylus writing function in the color electrophoretic displays accentuates the time delay in displaying the screen image. In the aforementioned embodiments, the response time necessary for displaying black color (monochrome display) is comparatively shorter (i.e., shorter refresh time/faster refresh rate, or shorter delay time). For example, the response time necessary for displaying black color is smaller than 50 ms, or preferably smaller than 30 ms. The response time necessary for displaying chromatic color (especially a color mix of more than 2 different color particles) is comparatively longer, for example, 500 ms.

In other words, color electrophoretic displays face the problem of time delay due to the handwriting input process. There apparently exists a time lag between the dynamic input of handwriting movement and the corresponding display in the color electrophoretic display for the handwriting movement, or so-called latency. Therefore, to cope with the handwriting movement, the device needs to have a shorter refresh time, so that users can view their handwritten inputs on a real time basis without any latency. According to the research data, the visual recognizing time for naked eyes is as fast as 55-65 ms. Therefore, in preferable embodiments, latency of a color electrophoretic display should be less than 100 ms, 65 ms, 42 ms, 30 ms, or 20 ms. Subsequently, the display method of the color electrophoretic displays of the present disclosure will be presented to reduce the latency of processing handwriting inputs while providing an optimal effect of color trace, which can be applied to the aforementioned color electrophoretic displays 100, 100a, and various methods of displaying colors.

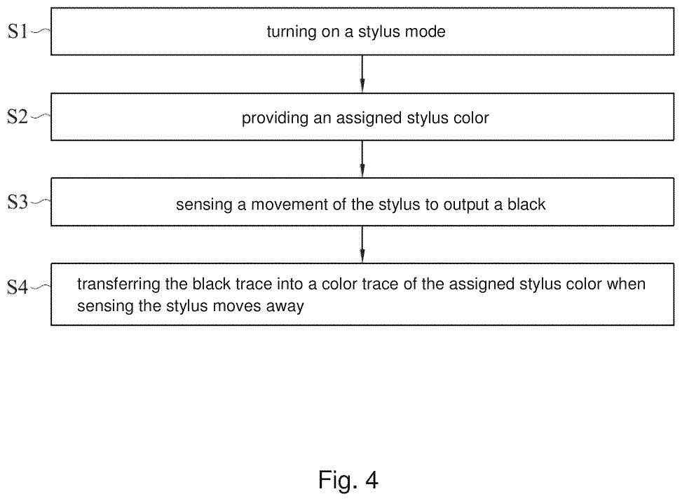

FIG. 4 is a display method of the color electrophoretic display based on one embodiment of the present disclosure. Step S1 turns on a stylus mode. For example, in one embodiment, the stylus mode of the color electrophoretic display can be achieved through the use of combining the capacitive touch sensor and the pressure sensor. The signals created by finger touch and the signals created by stylus have distinctively different polarity, and the signals that are not man-made (such as flicker noise for no reason) will not generate pressure on the display device. Therefore, the stylus mode has the effect of identifying the signals created by finger touch and by stylus. Specific driving methods of the stylus mode are not limited to those described above, and driving methods, which can enable the display device to generate corresponding responses to the handwritten inputs by the stylus, will work.

In another embodiment, the color electrophoretic display comprises an electromagnetic induction layer, which generally comprises a magnetic film and an electrode grid, in which the stylus tip used by the user comprises an induction coil. The movements of the induction coil during the handwriting process are converted to signals by the electromagnetic induction layer based on data concerning position, pressure, etc. At the same time, the input function of the stylus is carried out. In one embodiment, a passive stylus (i.e., a stylus without having a power source internally) is used in which the electric field thereof can be detected by the electromagnetic induction layer. In the embodiment, the pressure/electromagnetic signals from the electromagnetic induction layer are analyzed to determine the beginning or the end of the handwriting input process. For example, the pressure change from less than 0 or 0, to larger than 0 is regarded as a new beginning of a handwriting input process, whereas the pressure change from larger than 0, to less than 0 or 0 is regarded as an end of a handwriting input process.

In Step S1, when the stylus tip is close to the color electrophoretic display 100 and 100a, the stylus will generate a response signal. For example, an electric field, having synchronous oscillation with that of the resonant circuit of the electromagnetic induction layer, can automatically enable the stylus mode when the stylus tip is near (yet not touch) the color electrophoretic display. Or, the stylus mode can be activated by users through selecting the function on the displayed menu by using the stylus or by finger.

Step S2 assigns or selects a stylus color for writing traces. The stylus color can be one or multiple colors from the different mixes of the aforementioned chromatic color particles and achromatic color particles. How many mixes of colors specifically are determined will depend on what kind of color electrophoretic display is used (excluding black and white (achromatic color) display devices). The reason is that a single color, for instance, black or white color (achromatic color), has smaller latency in a color display process. For example, when the user selects the color of the stylus to be black or white while using the aforementioned driving method to an extreme state to control the positions of particles, the color electrophoretic display can directly display the trace using the designated color, without undergoing the achromatic/chromatic color assigning step described later.

Generally speaking, when the user selects a color with slower refresh rate (i.e., longer refresh time), the achromatic/chromatic color assigning method for the present disclosure can be used. On the contrary, when the user selects a color with faster refresh rate (for example, faster refresh rate than the visual recognizing speed of naked eyes), the handwritten traces can be displayed directly. More specifically, the color electrophoretic display of the present disclosure comprises an index table embedded internally (data stored in the memory chip of the display device) that records the refresh time of each color. When the user selects a color, the controller of the color electrophoretic display will conduct a matching step to figure out the refresh time of the assigned color. If the refresh time exceeds a specific value/constrain (for example, if the refresh time is larger than 20 ms, 30 ms, 42 ms, 65 ms, or 100 ms), the achromatic/chromatic color assigning method for the present disclosure is used. In one specific embodiment, when the refresh time of the assigned color is larger than 50 ms, the controller of the color electrophoretic display will not output the trace directly, and the following achromatic/chromatic color assigning method will be applied instead.

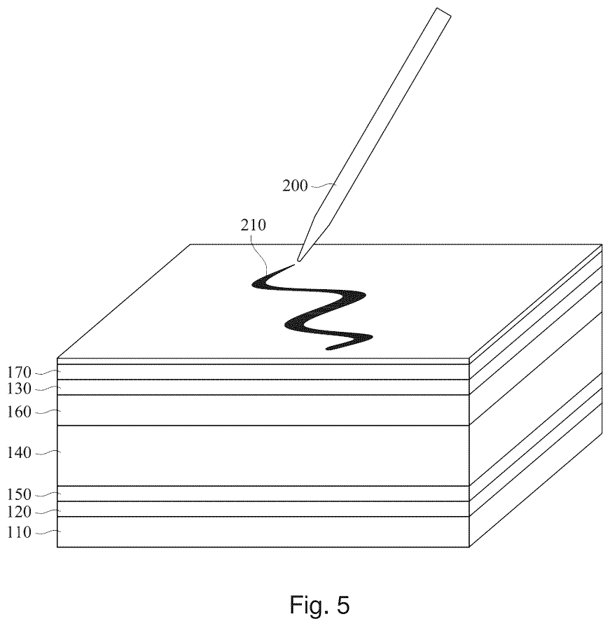

Please refer to FIG. 5. FIG. 5 is a schematic diagram of a trace-display step of the display method described in FIG. 4. In Step S3, the stylus 200 contacts the color electrophoretic display and moves around on the color electrophoretic display to create a black trace 210. The term “black trace” used in the embodiment is not limited to the trace color being solid black as defined in optics, for example, color of K=100 defined in CMYK color theme. The term “black trace” is for the convenience of explanation. The trace colors appear to be different in Step S3 and Step S4 (one shows achromatic color traces and the other shows chromatic color traces, when they are viewed by naked eyes). As shown in FIG. 3D, three different color particles are located above the white particles 142 after these three colors are mixed and viewed as black color (please note that while the black color is produced by a mix color in the embodiment, it is still an achromatic color (without color) from the view point of the user). In the embodiment, the pixels of the trace created by the stylus 200 appears as black color based on the aforementioned driving method, instead of showing the assigned stylus color defined in Step S2 directly. Therefore, the response time in Step S3 is less than 50 ms. As described previously, four types of particles, namely the white particles 142, cyan particles 144, yellow particles 146, and magenta particles 148, are driven by the maximum difference in voltage and move toward the top electrodes 130 at the fastest speed to engage in the color mixing process. Consequently, traces are displayed at the smallest response time so that users do not sense any latency.

In another embodiment, the aforementioned four types of particles are produced with magnetic feature. When a combined driving method is used, for example, a combination of electric field and magnetic field, the aforementioned particles are driven to move toward the top electrodes 130 at the fastest speed to engage in the color mixing process.

Pixels of the black trace 210 illustrated in FIG. 5 can be referenced in FIG. 3D. The cyan particles 144, yellow particles 146, and magenta particles 148 corresponding to the pixels of the black trace 210 all move above the white particles 142.

Generally speaking, Step S3 displays the traces of stylus movements using the color with fastest (i.e., as fast as possible) refresh rate in the color electrophoretic display selectively, so that users can see the position and appearance of handwritten inputs immediately while writing. As mentioned above, the color electrophoretic display has an index table embedded that records the refresh time of each color in the display device. The control chip of the color electrophoretic display will search the index table for a color with the fastest refresh rate to display the handwritten traces with high priority. There is a gap between the tip of the stylus/touch screen pen and the endpoint of the handwritten trace output in the color electrophoretic display. This gap can be referred to as the so-called latency. The embodiment of the present disclosure can significantly reduce this gap and let the handwritten trace appear at the same position of the pen tip as much as possible. The length of the aforementioned gap is associated with the writing speed of the user and the delay time. For an example, when the handwriting movement occurs at a steady speed, selecting a color with the fastest refresh rate (i.e., smallest delay time) to appear on the display screen with higher priority can significantly reduce the aforementioned gap and meet the requirements of pen writing operations. In the embodiment, since black color is the display color with the fastest refresh rate (50 ms), black is used as the display color of handwritten trace in the embodiment. Generally, the handwriting speed is about 60 mm/s. The aforementioned gap is about 3 mm by calculation. In other words, if the gap can be retained within 3 mm, the latency of handwriting output can be effectively reduced or can be ignored.

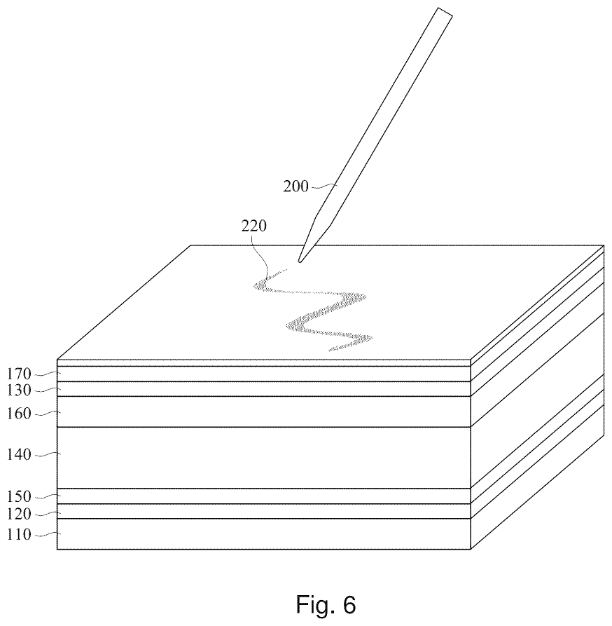

Please refer to FIG. 6. FIG. 6 is a schematic diagram showing the middle steps for changing the trace color of the display method described in FIG. 4. In step S4, the black/achromatic trace 210 is transferred into a color/chromatic trace 220 of the assigned stylus color in Step S2 when the stylus 200 moves away or stops moving. Please note that the trace in FIG. 6 is a color/chromatic trace, not a gray trace. For example, when the pressure value becomes smaller, it is determined that the handwriting input process has ended. The black trace 210 then undergoes an achromatic/chromatic color assigning process to display the handwritten trace in the assigned color by the user. In the embodiment, the pixels of the trace created by the stylus 200 appears in the assigned color in Step S2. FIG. 6 is a schematic diagram illustrating the pixels of the color trace 220, in which the color particle distribution is referred to, but not limited to, those of red color in FIG. 3C. The color trace 220 can be a mix of one or multiple types of color that appears as the color created by the cyan particles 144, yellow particles 146, magenta particles 148, and white particles 142 reflecting the incident light from outside or the light source built within the device while moving toward the top electrodes 130 in the driving mode.

The color of the assigned stylus color and the color of the black trace have the brightness difference and at least one of the hue differences or the saturation differences. In the embodiment, for example, when the color is transferred from black to red, there are changes in brightness, hue, and saturation in chromatics. In comparison with the present disclosure, the aforementioned patent of the related art only has changes in brightness in gray color/gray-scale during the movement of black and white particles, and the gray-scale system of the black and white particles does not require any control since it is a natural phenomenon.

In Step S3, the black trace 210 (for example, a color with the fastest refresh speed) is displayed first, and users will not sense the latency of the handwritten process. Step S3 is followed by Step S4. Although Step S4 takes approximately 500 ms (depending on the assigned color) to complete, given the black trace 210 been displayed already, the latency in displaying the color trace 220 will not be significant and therefore Step S4 has the effect of improving the experience of the user. In one embodiment, the color assigned in Step S3 has higher refresh rate than that of the assigned color in Step S2. More specifically, the refresh time of the color assigned in Step S2 is 5-10 times larger than that of the color assigned in Step S3. For example, the refresh time of the black color in the embodiment is 50 ms, whereas the refresh time of a red color is 500 ms.

In another alternative embodiment, in order to prevent a significant difference from occurring between the displayed color in Step S3 and the assigned color by the user in Step S2, the displayed color in Step S3 should be highly similar to the assigned color by the user in Step S2 while meeting the goal of reducing the latency. While not wanting to be limited by theory of color difference (Δ E) to human eyes, it is believed that, when Δ E of two different colors is smaller than 3.2, naked eyes cannot distinguish between these two colors. When A E of two different colors is 3.2<Δ E<6.5, naked eyes will perceive these 2 colors to be the same basically. When Δ E of two different colors is 6.5<Δ E<13, naked eyes will perceive these 2 colors as having the same hue. When Δ E of two different colors is larger than 13, naked eyes will perceive these two colors as having different hues (i.e., two different colors for human eyes). Therefore, when the user assigns a specific color (in Step S2), the control chip of the color electrophoretic display will perform the following sub-steps: determining whether the color difference of the assigned stylus color (in Step S2) and the color of the black trace (the color having the fastest fresh rate) is larger than 13. If Δ E is larger than 13, the system alternatively selects a group of colors from the index table that has a color difference Δ E less than 13 in comparison with the assigned color of the user (in other embodiments, threshold of Δ E can be set as 6.5, 3.2, or any suitable value). A color is then assigned from the aforementioned group of colors, which has the fastest refresh speed/rate in that group of colors, as the trace color. If all colors from the index table have a color difference Δ E larger than 13 in comparison with the assigned color of the user, a color having the fastest refresh rate in the display system is then assigned to be the trace color. Thus, the latency can be reduced, and also the uncomfortable visual experience of the user caused by the effect of switching trace color can be minimized.

In several embodiments, the method of the present disclosure can be implemented to a color electrophoretic display having four different color particles. Since the display method of the present disclosure is to display the black trace 210 (i.e., the color having the fastest refresh rate in the display system) corresponding to writing of the user and then display the assigned color, the required time for adjusting color particles in Steps S3 and S4 is not restricted and the method still has the effect on improving the experience of the user.

The present disclosure further provides an alternative embodiment of the display method of color electrophoretic displays. In the embodiment, the display method is different from the aforementioned display method by having a step of assigning a stylus color after the step of outputting the black trace 210 is completed. In other words, the above step S2 is moved to after the above step S3.

The aforementioned steps of transferring the black trace 210 into a color trace 220 comprises transferring the hue. Transferring the hue means that the aforementioned step of changing the arranged positions of color particles. In some embodiments, the transferring step further comprises transferring the brightness and saturation. Transferring the brightness can be determined by the positions of the white particles 142 that serve as the reflective layer. Transferring the saturation can be determined by the positions of the chromatic color particles.

In summary, the display method of the color electrophoretic display of the present disclosure outputs a black trace or the color having the highest refresh rate in the display system first and then display the assigned color, so that users will not sense the latency problem of the output trace. The color trace is displayed after the black trace is displayed. Given that the black trace 210 has been displayed already, the latency in displaying the color trace will not be significant to the human eyes, so that the display method has the effect of improving the experience of the user. Therefore, the display method of the color electrophoretic display of the present disclosure provides the effects of reducing the latency in outputting traces while displaying color traces. However, one specific display method of the color electrophoretic display is to use a color filter to create red, green, and blue colors, followed by displaying the chromatic color through color mixing. The color electrophoretic displays implemented with such display method do not involve the movement of color particles. Hence, the achromatic/chromatic color assigning method of the present disclosure may not be applicable to color electrophoretic displays with color filters (however, the present disclosure does not exclude such type of color electrophoretic displays).

The present disclosure mainly applies two color-display steps for the achromatic/chromatic color assigning method to solve the latency problem caused by the movements of different color particles of a system with multiple color particles. During the handwriting step, a color with the shortest refresh time is assigned as the trace color, so that the user will not sense the latency. For example, the gap between the tip of the stylus/touch screen pen and the endpoint of the handwritten trace output in the color electrophoretic display is restricted to be less than 3 mm, followed by applying the assigned color to the output trace to display the stylus color pre-selected by the users.

The above preferred embodiments are presented to disclose the present disclosure and should not be interpreted to limit the scope, applicability, or configuration of the present disclosure in any way. Those skilled in the art may use any alternative embodiments that are modified or changed without departing from the spirit and scope of the present disclosure. Therefore, the protection scope of the present disclosure should depend on the scope of patent application as defined according to the following appended claims.

### COMPONENT SYMBOL

10 substrate
120 bottom electrode
130 top electrode
140 electrophoretic medium
142 white particle
144 cyan particle
146 yellow particle
148 magenta particle
150, 160: adhesive layer
170 protective layer
200 stylus
210 black trace
220 color trace
S1-S4: step

What is claimed is:

1. A display method of a color electrophoretic display, in which the color electrophoretic display comprises an achromatic color particle and a plurality of chromatic color particles, comprising:
S1: turning on a stylus mode;
S2: providing an assigned stylus color;
S3: sensing a movement of a stylus to output a black trace, in which a color of the black trace is shown when the achromatic color particle and the chromatic color particles move toward a top electrode, and a refresh time of the color of the black trace is smaller than 50 ms; and
S4: transferring the black trace into a color trace of the assigned stylus color when the movement of the stylus stops, in which a color of the assigned stylus color and the color of the black trace have a brightness difference and at least one of a hue difference or a saturation difference.

2. The display method of the color electrophoretic display as claimed in claim 1, wherein the color of the black trace has a shortest refresh time among colors of the color electrophoretic display.

3. The display method of the color electrophoretic display as claimed in claim 1, wherein a refresh time of the assigned stylus color is 5-10 times that of the color of the black trace.

4. The display method of the color electrophoretic display as claimed in claim 1, wherein the achromatic color particle is a white particle, and the chromatic color particles are cyan particles, yellow particles, and magenta particles.

5. The display method of the color electrophoretic display as claimed in claim 1, wherein a distance between the black trace and a stylus tip of the stylus is smaller than 3 mm.

6. The display method of the color electrophoretic display as claimed in claim 1, further comprising:
determining whether a color difference between the assigned stylus color and the color of the black trace is larger than 13; and
when the color difference is larger than 13, selecting a group of colors, each color in the group of colors having a color difference less than 13 from the assigned stylus color, and assigning a color having a shortest refresh time from the group of colors to present a trace of the stylus in the S3.

7. The display method of the color electrophoretic display as claimed in claim 1, wherein the S3 further comprises: sensing a pressure of the stylus pressing against the color electrophoretic display to determine that the stylus touches the color electrophoretic display and begins to draw based on the pressure increasing.

8. The display method of the color electrophoretic display as claimed in claim 1, wherein the S4 further comprises: sensing a pressure of the stylus pressing against the color electrophoretic display to determine that the stylus moves away from the color electrophoretic display and stops drawing based on the pressure decreasing.

9. The display method of the color electrophoretic display as claimed in claim 1, wherein the S2 is provided before the S3 or after the S3.

10. A color electrophoretic display, comprising.
an achromatic color particle and a plurality of chromatic color particles, wherein
the color electrophoretic display presents color trace, formed by movement of a stylus, and the color trace is shown when the achromatic color particle and the chromatic color particles move toward a top electrode;
a distance between an endpoint of the color trace and a tip of the stylus is smaller than 3 mm; and
the color electrophoretic display does not comprise color filters.

11. The color electrophoretic display as claimed in claim 10, wherein the color trace is presented in an assigned color from a color having a highest refresh rate.

12. The color electrophoretic display as claimed in claim 10, wherein the color trace is presented in a first color which is assigned by user from a second color having a refresh time less than 50 ms.

13. The color electrophoretic display as claimed in claim 10, wherein the achromatic color particle is a white particle and the chromatic color particles are cyan particles, yellow particles, and magenta particles.
